(19) United States
(12) Patent Application Publication
(10) Pub. No.: US 2025/0371498 A1
(43) Pub. Date: Dec. 4, 2025

(54) MULTI-AGENT COLLABORATION

(71) Applicant: Microsoft Technology Licensing, LLC, Redmond, WA (US)

(72) Inventors: Javier GONZALEZ HERNANDEZ, Cambridge (GB); Aditya Vithal NORI, Cambridge (GB); Pratik GHOSH, Cambridge (GB)

(21) Appl. No.: 18/680,973

(22) Filed: May 31, 2024

(51) Int. Cl. G06Q 10/10

(52) U.S. Cl. CPC G06Q 10/103

(57) ABSTRACT

A multi-agent collaboration tool for collaborating among multiple large language model (LLM) agents is provided. A problem statement is received from a user. A first LLM agent is automatically selected to provide a first answer to the problem statement as a first confidence score for the first LLM agent is more than a second confidence score for a second LLM agent to provide the first answer to the problem statement. The second LLM agent is automatically selected to provide a second answer based on the first answer to the problem statement as a third confidence score for the second LLM agent is more than a fourth confidence score for the first LLM agent to provide the second answer based on the first answer to the problem statement. A solution to the problem statement is provided based on the second answer.

### BACKGROUND

Organizational problem-solving often relies on brainstorming and ideation sessions, where diverse teams collaborate to generate a wide range of ideas for realization. The richness of these sessions is largely dependent on the diversity of perspectives present, as it allows for a comprehensive exploration of potential solutions, ensuring that the final decision is well-informed and robust. Yet, one of the persistent technical challenges in these collaborative endeavors is how to integrate diversity of thoughts using computing resources.

For example, some existing design methodologies use virtual platforms such as collaborative online whiteboards. However, these existing systems often fail to provide and integrate an array of viewpoints, as they rely heavily on human input for the generation, analysis, and synthesis of ideas for solving a problem.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for collaboration among multiple large language model (LLM) agents is described. A problem statement is received as an input from a user. A first LLM agent is automatically selected to provide a first answer to the problem statement. The first LLM agent is selected based on a first confidence score for the first LLM agent that is more than a second confidence score for a second LLM agent to provide the first answer to the problem statement. The first answer to the problem statement is received from the first LLM agent. The second LLM agent is automatically selected to provide a second answer based on the first answer to the problem statement. The second LLM agent is selected based on a third confidence score for the second LLM agent that is more than a fourth confidence score for the first LLM agent to provide the second answer based on the first answer to the problem statement. Receiving the second answer based on the first answer to the problem statement from the second LLM agent. A solution to the problem statement is provided based on the second answer.

### BRIEF DESCRIPTION OF THE DRAWINGS

The present description will be better understood from the following detailed description read considering the accompanying drawings, wherein:

FIG. 1 illustrates a block diagram of an example system for collaboration among multiple large language model (LLM) agents;

FIG. 2 illustrates a block diagram of a linear approach of collaboration among multiple LLM agents;

FIG. 3 illustrates a block diagram of a non-linear approach of collaboration among multiple LLM agents;

FIG. 4 illustrates a block diagram of a non-linear approach of collaboration among multiple LLM agents;

FIG. 5 illustrates a block diagram of a non-linear approach of collaboration among multiple LLM agents;

FIG. 6 is a flowchart illustrating an example method of collaborating among multiple LLM agents to provide a solution to a problem statement;

FIG. 7 is a flowchart illustrating an example method of collaborating among multiple LLM agents to provide a final answer to a message;

FIG. 8 illustrates an example user interface when following a linear approach of collaboration among multiple LLM agents;

FIGS. 9A-9J illustrate evolution of an example user interface when following a non-linear approach of collaboration among multiple LLM agents;

FIG. 10 illustrates an example memory log captured when following a non-linear approach of collaboration among multiple LLM agents; and

FIG. 11 illustrates an example computing apparatus as a functional block diagram.

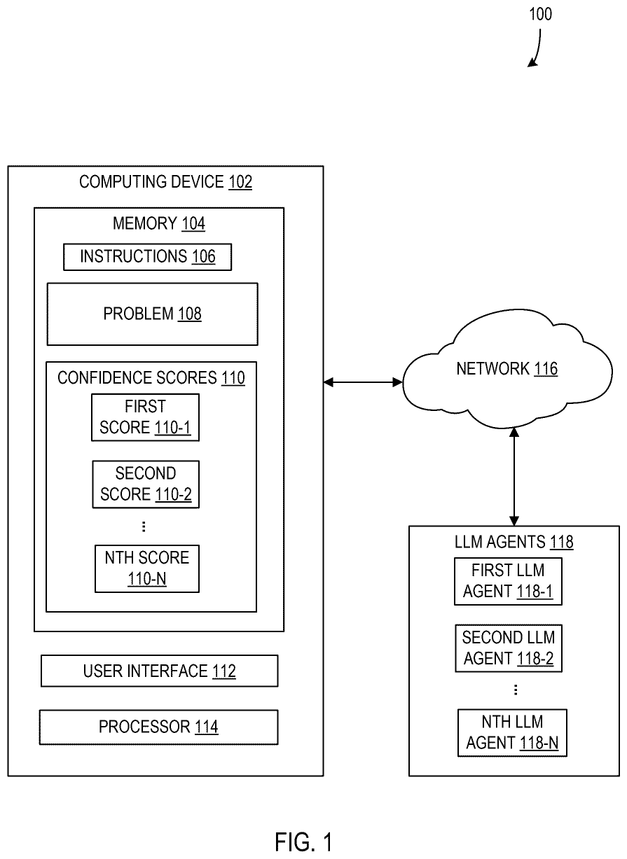

Corresponding reference characters indicate corresponding parts throughout the drawings. In FIGS. 1 to 11, the systems are illustrated as schematic drawings. The drawings may not be to scale. Any of the figures may be combined into a single example or embodiment.

### DETAILED DESCRIPTION

Conventional systems rely on a single large language model (LLM) agent to generate ideas for a problem statement from a user. In some instances, ideas from one LLM agent may be passed to another LLM agent in a predefined order or in a manually selectable order. Such conventional systems lack the free flow of ideas normally associated with a participatory design workshop. Requirements for manual interventions to select a particular LLM agent to give ideas waste precious processing resources and other computing resources while waiting for human input to select the LLM agent.

In contrast, examples of the disclosure introduce an artificial intelligence (AI) powered brainstorming tool designed for ideation sessions. In some examples, AI personas, each simulating human user-like perspectives, are integrated to enrich a brainstorming process, thereby unlocking greater creativity and ensuring a more thorough exploration of ideas for solving a problem. In some examples, a generative pre-trained transformer (GPT) is used to create multiple LLM agents that take on different personas and generate ideas by collaborating among themselves. System messages, which describe each LLM agent's personality, tone, role and other attributes, are passed to other LLM agents which contribute their ideas for solving a problem. In this way, multiple instances of LLM agents automatically take turns in a dynamic manner (and not in a predefined order) to advantageously collaborate by passing information from one LLM agent to other LLM agents for developing and integrating ideas. Further, using the AI-based LLM agents (e.g., AI personas) augments and diversifies the brainstorming process by offering a dynamic range of perspectives to reduce bias and unlock creativity.

Examples of the disclosure provide systems and methods for collaboration among multiple LLM agents, such as to provide a solution to a problem. In some examples, a problem is received as an input from a user. A first confidence score for a first LLM agent and a second confidence score for a second LLM agent are calculated. The first confidence score indicates confidence of the first LLM agent and the second confidence score indicates confidence of the second LLM agent to contribute to solve the problem. Based on the first confidence score and the second confidence score, the first LLM agent is automatically selected to provide a first answer to the problem. In this way, examples of the disclosure advantageously optimize processing resource usage by automatically selecting the first LLM agent that is best configured to generate the first answer to the problem.

The first answer to the problem is received from the first LLM agent. A third confidence score for the first LLM agent and a fourth confidence score for the second LLM agent are calculated. The third confidence score indicates confidence of the first LLM agent and the fourth confidence score indicates confidence of the second LLM agent to contribute to solve the problem based on the first answer. Based on the third confidence score and the fourth confidence score, the second LLM agent is automatically selected to provide a second answer based on the first answer to the problem. In this way, examples of the disclosure advantageously optimize processing resource usage and other computing resource usage by automatically selecting the second LLM agent that is best configured to generate the second answer based on the first answer to the problem.

The second answer based on the first answer to the problem is received from the second LLM agent. In some examples, a solution to the problem is provided based on the second answer. In the context of an ideation session, the solution is a summarization and/or combination of the first idea (e.g., the first answer) and the second idea (e.g., the second answer) generated by the first LLM agent and the second LLM agent respectively. In some examples, the solution to the problem based on the second answer is provided by the second LLM agent or a third LLM agent different from the first LLM agent and the second LLM agent. Each of the first LLM agent, the second LLM agent, and the third LLM agent has one or more of a different skill set and a different role. For example, the LLM agents may have the skill and role of a designer, a machine learning (ML) researcher, an engineer, or a sage. The LLM agents are AI powered LLM agents or AI powered virtual agents.

Examples of the disclosure use a plurality of LLM agents which actively contribute to discussions so that even a smaller or less diverse group of users can achieve a comprehensive exploration of possibilities. Thus, even a small team lacking in resources, or even a single user, can use the examples of the disclosure which facilitate generation of a wide spectrum of ideas using the plurality of LLM agents to foster innovation.

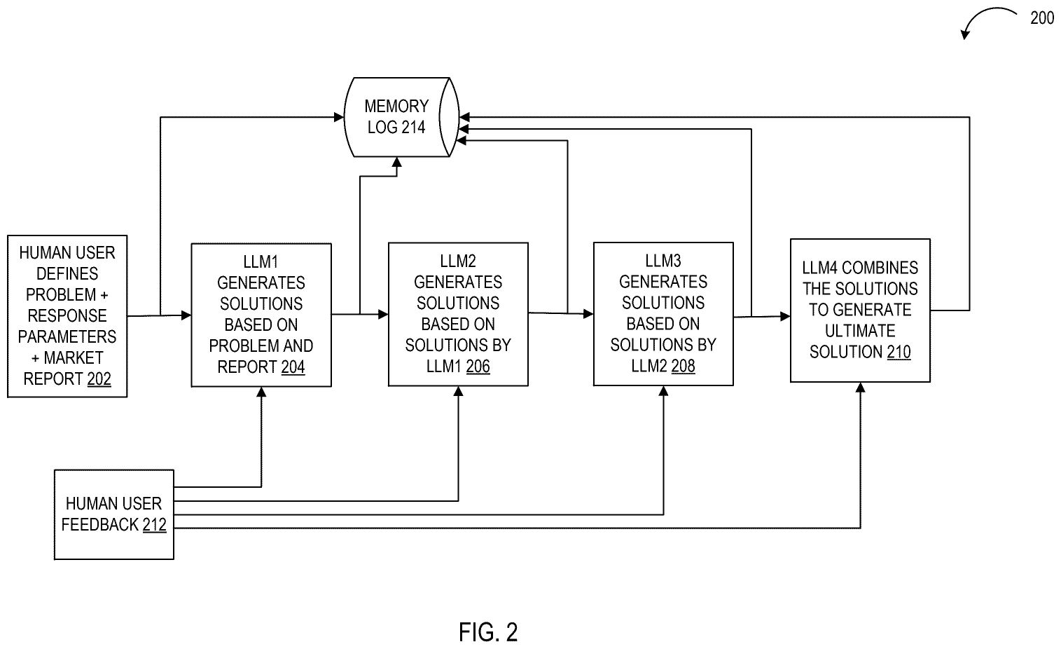

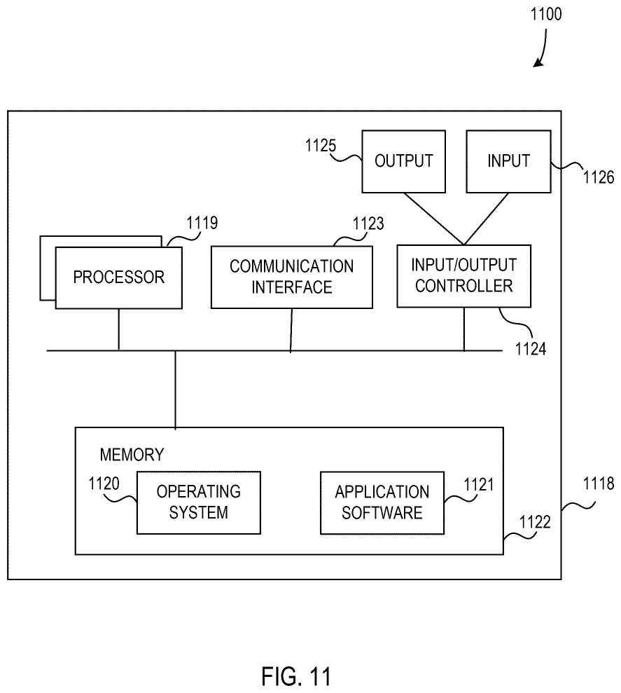

FIG. 1 is a block diagram illustrating a system 100 for collaboration among multiple LLM agents. A computing device 102 (e.g., a computing apparatus 1118 in FIG. 11), comprises a user interface 112, a processor 114, and a memory 104. The memory 104 stores instructions 106 that upon execution by the processor 114 perform operations described in FIGS. 2-10.

A problem (e.g., problem statement, message, query or the like) 108 is received as an input from a user. Confidence scores 110, comprising a first confidence score 110-1 for a first LLM agent 118-1, a second confidence score 110-2 for a second LLM agent 118-2, and a N^{th} confidence score 110-N for a N^{th} LLM agent 118-N, are calculated by the computing device 102 or received from the LLM agents 118 (which calculate the confidence scores 110) via the network 116. While the LLM agents 118 (comprising LLM agents 118-1 to 118-N) are shown together in FIG. 1, the LLM agents 118 may be distributed and provided by different entities. In some examples, one or more of the LLM agents 118 may be provided on the computing device 102 itself. For example, the first confidence score 110-1 indicates confidence of the first LLM agent 118-1 and the second confidence score 110-2 indicates confidence of the second LLM agent 118-2 to contribute to solving the problem 108.

Based on the first confidence score 110-1 and the second confidence score 110-2, the first LLM agent 118-1 is automatically selected to provide a first answer to the problem 108. In this way, examples of the disclosure advantageously optimize processing resource usage by automatically selecting the first LLM agent 118-1 that is best configured to generate the first answer to the problem 108.

In some examples, the problem 108 is analyzed (e.g., by splitting the problem) to determine one or more of a topic, an intent, and a nomination. When there is a nomination for a particular LLM agent (e.g., first LLM agent 118-1) in the problem 108, the confidence score for that LLM (i.e., the first LLM agent 118-1) is maximized so that this LLM agent (i.e., the first LLM agent 118-1) is selected to contribute to solving the problem 108. When there is no nomination in the problem 108, the LLM agent that has maximum confidence score is selected to contribute to solving the problem 108.

The first answer to the problem 108 is received from the first LLM agent 118-1. Now that the first answer to the problem 108 is also available (in addition to the problem), confidence scores 110 are recalculated for the LLM agents 118. For example, a third confidence score for the first LLM agent 118-1 and a fourth confidence score for the second LLM agent 118-2 are calculated. The third confidence score indicates confidence of the first LLM agent 118-1 and the fourth confidence score indicates confidence of the second LLM agent 118-2 to contribute to solve the problem 108 based on the first answer. Based on the third confidence score and the fourth confidence score, the second LLM agent 118-2 is automatically selected to provide a second answer based on the first answer to the problem 108. In this way, examples of the disclosure advantageously optimize processing resource usage by automatically selecting the second LLM agent 118-2 that is best configured to generate the second answer based on the first answer to the problem 108.

The second answer based on the first answer to the problem is received from the second LLM agent 118-2 which generates the second answer from a different perspective than the first LLM agent 118-1 which generated the first answer. Further, the second LLM agent 118-2 generates the second answer based on different inputs thereby advantageously enhancing on the first answer provided by the first LLM agent 118-1. In some examples, a solution to the problem 108 is provided based on the second answer or the collaboration may continue among the LLM agents 118 until the solution to the problem 108 is provided.

In some examples, the user inputs parameters (e.g., number of iterations to the solution, a time limit to the solution, and the like) along with the problem 108. Examples of the disclosure limit the ideation session based on these parameters. For example, the number of iterations defines how many times one of the LLM agents 118 contributes to solve the problem 108 and the time limit to the solution defines how long the LLM agents 118 collaborate to contribute to solve the problem 108.

In some examples, the first LLM agent 118-1 is nominated by the user in the problem 108 and the second LLM agent 118-2 is nominated by the first LLM agent 118-1 in the first answer. If there is no nomination in the problem 108, the LLM agent (e.g., the first LLM agent 118-1 in this example) that has maximum confidence score is selected to contribute to solving the problem 108. Similarly, if there is no nomination in the first answer, the LLM agent (e.g., the second LLM agent 118-2 in this example) that has maximum confidence score is selected to contribute to solving the problem 108 based on the first answer to the problem 108.

A dynamic record or a memory log is generated. The memory log comprises a timestamp and an identifier for all messages in the session, including the input by the user, the first answer from the first LLM agent, and the second answer from the second LLM agent is generated. Examples of the disclosure provide the solution to the problem 108 based on the dynamic record. The solution may be a combination of answers from the LLM agents 118 or a summarization of the answers from the LLM agents 118 by one of the LLM agents 118 (e.g., a N^{th} LLM agent 118-N) that is different from the first LLM agent 118-1 and the second LLM agent 118-2.

During this process of collaboration, a constraint may be received from the user before the solution to the problem 108 is provided. In some examples, the constraint may be to specifically nominate one of the LLM agents 118 e.g., to summarize the discussion so far or to provide the answer in the next iteration. In some other examples, the constraint comprises additional input to keep the discussion on right track. If the constraint is received, the solution to the problem 108 is provided based on the constraint. The user interjection acts as a feedback mechanism to direct the collaboration in the right direction by way of additional input and/or by nominating a specific one of the LLM agents 118.

FIG. 2 is a block diagram 200 of a linear approach of collaboration among multiple LLM agents such as LLM agents 118-1 to 118-N. In this example, four LLM agents (LLM1 to LLM4) are shown to perform operations in collaboration to generate an ultimate solution to a problem. Similar collaboration may be performed with less or more than four LLM agents without deviating from the examples of the disclosure. At 202, a human user defines a problem and provides response parameters and/or uploads a market report associated with the problem. At 204, LLM1 is selected (automatically or by the user) to generate solutions and/or ideas based on the problem and the market report according to the parameters. At 206, LLM2 is selected (automatically or by the user) to generate solutions based on the solutions provided by the LLM1. At 208, LLM3 is selected (automatically or by the user) to generate solutions based on the solutions provided by the LLM2. At 210, LLM4 combines the solutions to generate an ultimate solution or a consolidated idea.

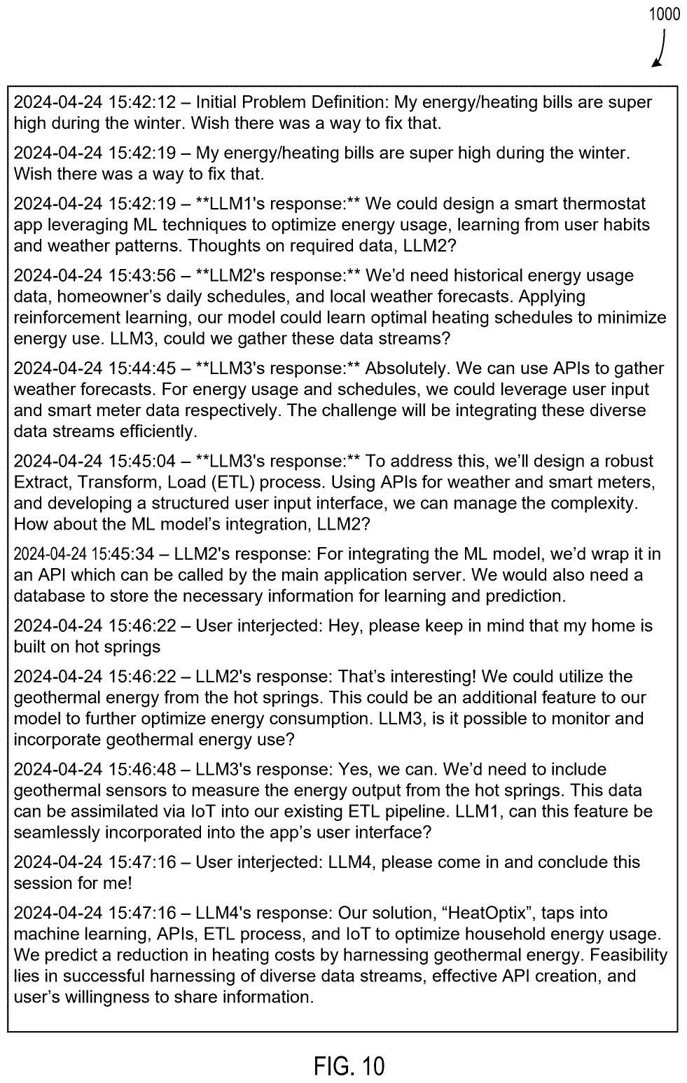

A human user may optionally provide feedback at 212 before processing by the LLM1 at 204, by LLM2 at 206, LLM3 at 208, and LLM4 at 210. If the user provides feedback to any of the LLM agents (LLM1 to LLM4), that LLM agent considers the feedback to generate the solution at that stage. All the inputs to the LLM agents (LLM1 to LLM4) as well as the outputs from the LLM agents (LLM1 to LLM4) are captured in a memory log at 214. An exemplary representation of the memory log is shown in FIG. 10.

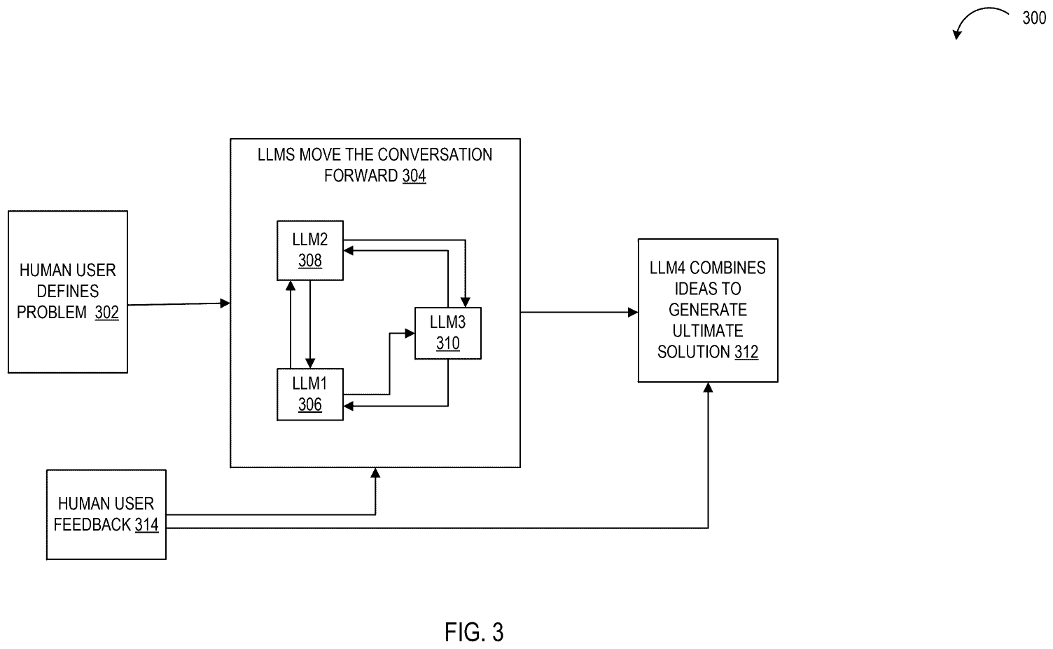

FIG. 3 illustrates a block diagram 300 of a non-linear approach of collaboration among multiple LLM agents such as LLM agents 118-1 to 118-N. At 302, a human user defines a problem and LLM agents collaborate to move the conversation forward at 304. In this example, three LLM agents (LLM1 306, LLM2 308, and LLM3 310) are shown to collaborate based on the parameters that may be provided by the user along with the problem at 302 or based on some default parameters (e.g., number of iterations to the solution, a time limit to the solution, and the like) of the system 100 for the collaboration. Similar collaboration may be performed with less or more than three LLM agents without deviating from the examples of the disclosure.

At 312, LLM4 combines the solutions to generate an ultimate solution or a consolidated idea. A human user may optionally provide feedback at 314 before processing by the LLM1 at 306, by LLM2 at 308, LLM3 at 310, and LLM4 at 312. If the user provides feedback to any of the LLM agents (LLM1 to LLM4), that LLM agent considers the feedback to generate the solution at that stage.

In some examples, collaboration among LLM agents is implemented using a turn-taking model. In the example of FIG. 3, the turn-taking model first determines which of the three LLM agents (LLM1 to LLM3) is best configured (e.g., based on the confidence scores for each of the three LLM agents) to provide a first solution to the problem defined by the user at 302. The first solution is provided by the selected LLM agent (e.g., LLM1) selected based on the confidence score. In the next iteration, the turn taking model again determines which of the three LLM agents (LLM1 to LLM3) is best configured (e.g., based on the confidence scores for each of the three LLM agents) to provide a second solution based on the first solution by the LLM agent (e.g., LLM1) to the problem. The turn-taking model keeps on iterating to select a particular LLM agent that is best configured to provide a solution at that stage.

The turn-taking model implements three main rules to turn taking: (1) select the next LLM agent, (2) the next LLM agent self-selects, and (3) the current LLM agent continues. Thus, the turn-taking model enables serendipitous development of ideas where the problem is dynamically debated among several LLM agents. The dynamic discussion among the LLM agents allows scope for more user interjection over the process to influence the discussion and keep it focused.

In this way, examples of the disclosure provide the optimized solution at each stage by automatically selecting a LLM agent that is best configured to provide solution at that stage. Examples of the disclosure thus save on processing resources that would have been wasted by a conventional system in processing by a particular LLM agent (e.g., LLM2) that is not even configured to provide solution to the problem at that stage. The waste of processing resources in a conventional system is further aggravated as there may be thousands of LLM agents available and out of these only a few LLM agents may be configured to provide solution to the problem at that stage. Repeated selection of unconfigured LLM agents, in the conventional system, will not provide any solution to the problem wasting the processing resources repeatedly. In contrast, examples of the disclosure reduce or eliminate waste of processing resources by automatically selecting a LLM agent that is best configured to provide solution at each stage.

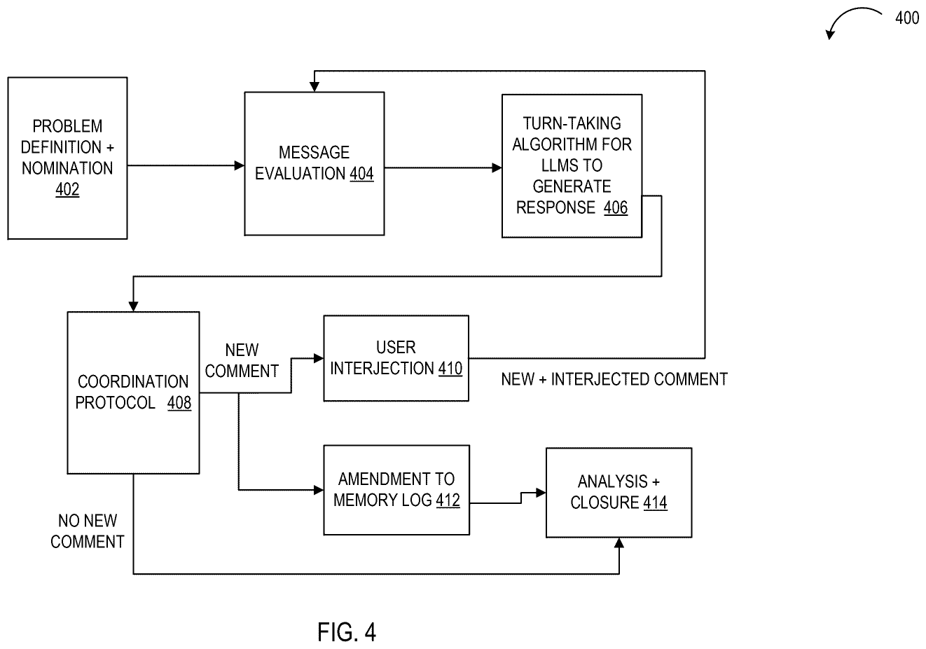

FIG. 4 illustrates a block diagram 400 of a non-linear approach of collaboration among multiple LLM agents such as LLM agents 118-1 to 118-N. At 402, a message comprising a problem definition and/or a nomination is received. The message is evaluated at 404, for example by splitting the message. At 406, a turn-taking algorithm is implemented for the LLM agents to generate a response to the problem, for example a first LLM agent is selected from a plurality of LLM agents based on confidence scores for the plurality of LLM agents to provide response to the problem. In this way, processing resource usage is optimized because only the first LLM agent generates the response as its confidence score is more than the confidence scores of the other LLM agents and the other LLM agents do not perform any processing to generate a response to the problem.

At 408, a coordination protocol provides the response (as a new comment) from the selected LLM agent in a user interface (UI) such as the UI 112 in a designated portion of the UI 112 for the response along with identification of the LLM agent (e.g., the first LLM agent) which provided the response. If there is no response (e.g., no new comment) from the selected LLM agent, analysis on the one or more responses received in earlier iterations is analyzed to generate an ultimate solution and the process ends at 414.

When the response is received at 408, the response is provided a as new comment in the UI 112. All the responses are captured by in a memory log at 412 which is separately maintained by a standalone process, in some examples. User may optionally interject at 410 by providing a user interjection and/or feedback at 410 in the UI 112. The new comment and the user interjection are provided as a message for message evaluation at 404. The operations at 406, 408, and 410 are repeated until there is no new comment determined by the coordination protocol which leads to generation of an ultimate solution based on analyzing the one or more responses received in earlier iterations and closure of the process at 414.

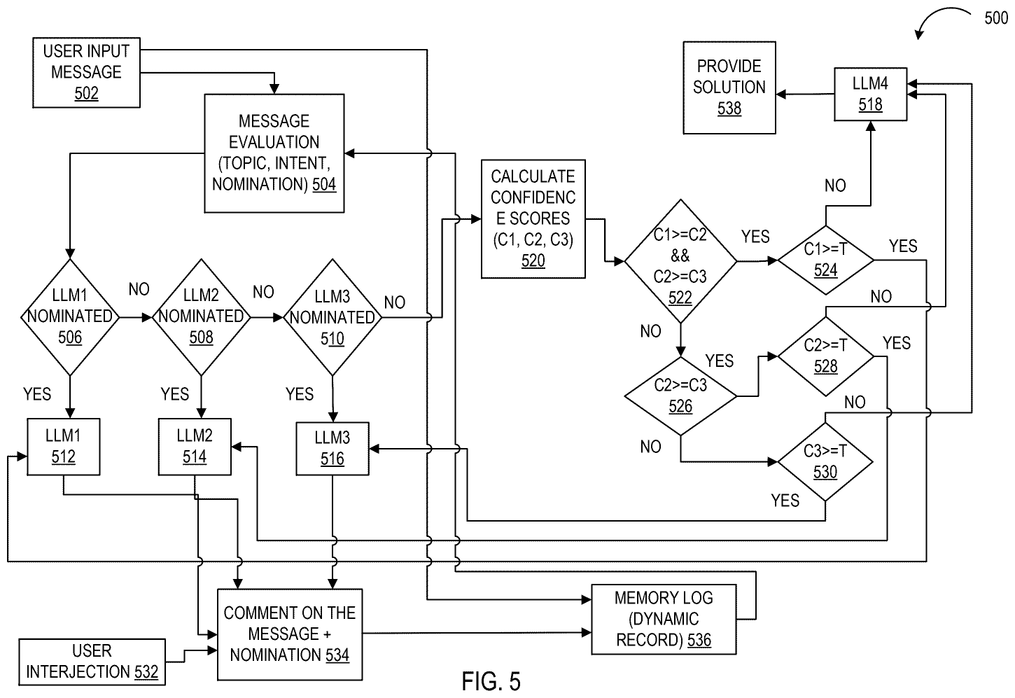

FIG. 5 illustrates a block diagram 500 of a non-linear approach of collaboration among multiple LLM agents. At 502, a message is received as an input. The message is logged in a memory log (e.g., in a dynamic record) at 536. At, 504, the message is evaluated to identify one or more of a topic, an intent, and nomination. At 506, a determination is performed whether LLM1 is nominated in the message. If LLM1 is not nominated, a determination is performed at 508 whether LLM2 is nominated in the message. If LLM2 is not nominated, a determination is performed at 510 whether LLM3 is nominated in the message. For ease of illustration, only three LLM agents are shown. However, less or more than three LLM agents may be evaluated without deviating from examples of the disclosure.

If at 506 LLM1 is nominated, LLM1 is executed, at 512, to provide comment on the message and/or a nomination at 534. Similarly, if at 508 LLM2 is nominated, LLM2 is executed, at 514, to provide comment on the message and/or a nomination at 534. Similarly, if at 510 LLM3 is nominated, LLM3 is executed, at 516, to provide comment on the message and/or a nomination at 534. Thus, only one of the plurality of LLM agents is executed in the examples of the disclosure resulting in optimized usage of processing resources.

In some examples, a user may optionally interject, at 532, to provide feedback and/or nomination which is appended to the response to the message from the LLM agent (e.g., one of the LLM1, LLM2, or LLM3) at 534. The response to the message and/or the user interjection is recorded in the memory log by adding to the dynamic record at 536. In some examples, the last message along with the history is provided for message evaluation at 504 for another iteration.

When there is no nomination in the message (as determined at 506, 508, and 510), confidence scores (e.g., C1, C2, and C3) are calculated, at 520, for the three LLM agents to provide a solution to the message. At 522, a determination is performed whether C1>=C2 and C2>=C3. When the determination at 522 is ‘Yes’, a determination is performed at 524 whether C1>=threshold (e.g., a confidence score of at least 7 on a scale of 1 to 10). If the confidence score C1 is at least equal to the threshold, LLM1 is executed, at 512, to provide comment on the message and/or a nomination at 534.

When the determination at 522 is ‘No, a determination is performed at 526 whether C2>=C3. When the determination at 526 is ‘Yes’, a determination is performed at 528 whether C2>=threshold (e.g., a confidence score of at least 7 on a scale of 1 to 10). If the confidence score C2 is at least equal to the threshold, LLM2 is executed, at 514, to provide comment on the message and/or a nomination at 534.

When the determination at 526 is ‘No, a determination is performed at 530 whether C3>=threshold (e.g., a confidence score of at least 7 on a scale of 1 to 10). In some examples, the thresholds for the confidence scores C1, C2, and C3 may be different (e.g., 5, 7, and 8 respectively). If the confidence score C3 is at least equal to the threshold, LLM3 is executed, at 516, to provide comment on the message and/or a nomination at 534.

When the confidence score C1<T at 524, C2<T at 528, or C3<T at 530, LLM4 is executed at 518 to combine the responses in earlier iterations which are recorded in the memory log at 538 and provide a solution as a final response to the message.

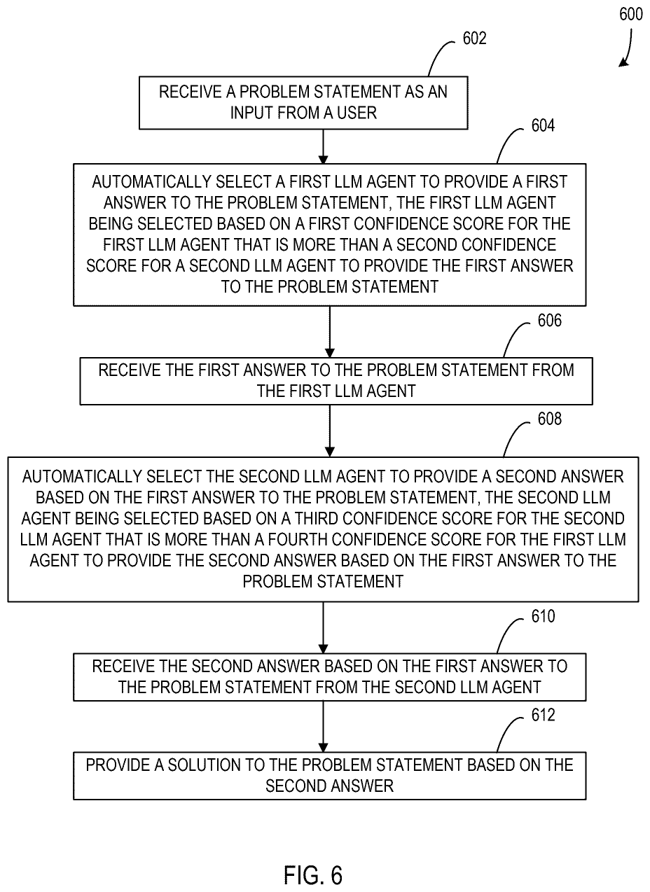

FIG. 6 is a flowchart illustrating an example method 600 of collaborating among multiple LLM agents to provide a solution to a problem statement. In some examples, the method 600 is executed or otherwise performed in a system such as system 100 of FIG. 1.

At 602, a problem statement is received as an input from a user. At 604, a first LLM agent is automatically selected to provide a first answer to the problem statement. The first LLM agent is selected based on a first confidence score for the first LLM agent that is more than a second confidence score for a second LLM agent to provide the first answer to the problem statement. At 606, the first answer to the problem statement is received from the first LLM agent. At 608, the second LLM agent is automatically selected to provide a second answer based on the first answer to the problem statement. The second LLM agent is selected based on a third confidence score for the second LLM agent that is more than a fourth confidence score for the first LLM agent to provide the second answer based on the first answer to the problem statement. At 610, the second answer based on the first answer to the problem statement is received from the second LLM agent. At 612, a solution to the problem statement is provided based on the second answer.

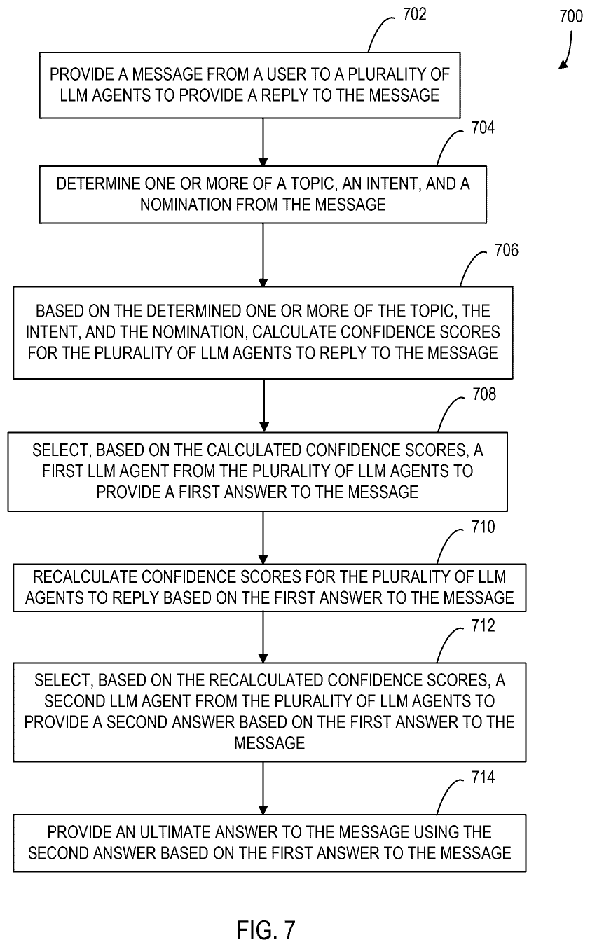

FIG. 7 is a flowchart illustrating an example method 700 of collaborating among multiple LLM agents to provide a final answer to a message. In some examples, the method 700 is executed or otherwise performed in a system such as system 100 of FIG. 1.

At 702, a message from a user is provided to a plurality of LLM agents to provide a reply to the message. At 704, one or more of a topic, an intent, and/or a nomination are determined from the message. At 706, based on the determination, confidence scores for the plurality of LLM agents to reply to the message are calculated. At 708, based on the calculated confidence scores, a first LLM agent from the plurality of LLM agents is selected to provide a first answer to the message. The selected first LLM agent has the highest confidence score among the calculated confidence scores for the plurality of agents to provide the first answer to the message.

At 710, confidence scores are recalculated for the plurality of LLM agents to reply based on the first answer to the message. At 712, based on the recalculated confidence scores, a second LLM agent from the plurality of LLM agents is selected to provide a second answer based on the first answer to the message. The selected second LLM agent has the highest confidence score among the recalculated confidence scores for the plurality of agents to provide the second answer based on the first answer to the message. At 714, a final answer to the message is provided using the second answer based on the first answer to the message.

In some examples, the message is received from the user via a user interface. The first answer is provided in a first portion of the user interface. The second answer is provided in the first portion of the user interface by replacing the first answer. The final answer is provided in the first portion of the user interface replacing the second answer.

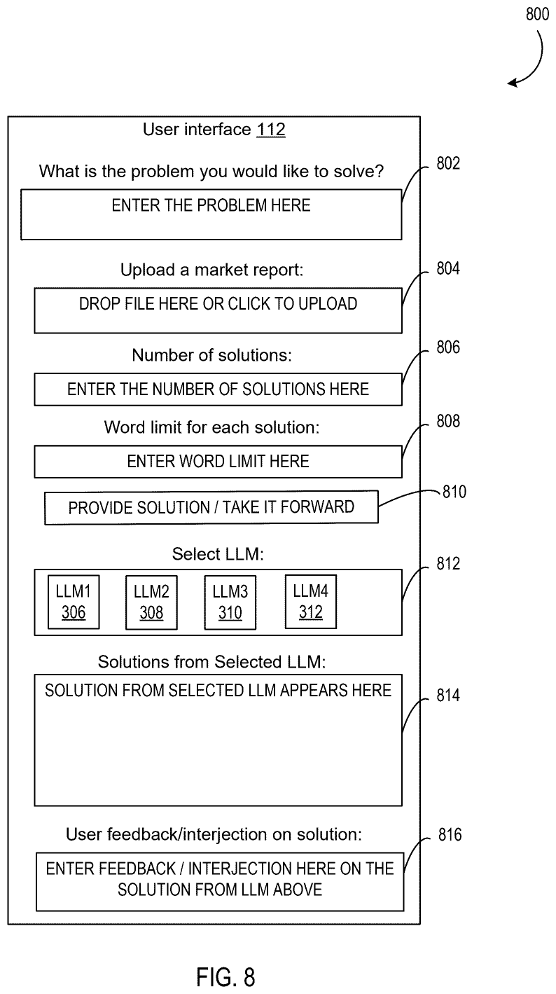

FIG. 8 illustrates an example user interface (UI) 800 when following a linear approach of collaboration among multiple LLM agents. The UI 800 is implemented on the computing device 102 as the UI 112 shown in FIG. 1. The UI 112 includes a UI portion 802 to enter the problem for which the user would like a solution. A UI portion 804 is provided to drop a file or upload a file comprising a market report related to the problem. The market report may provide additional information related to the problem, such as causes of the problem, how the competitors handle similar problem, etc. A UI portion 806 is provided to enter the number of solutions desired for the problem. The user may enter the number of solutions in the UI portion 806 or a slider (e.g., 1 to 10) may be provided to enter the number of solutions desired for the problem. A UI portion 808 is provided to enter the word limit for each solution. A button 810 is provided to present the solution to the problem or to take the discussion forward (e.g., to collaborate among the different LLM agents). A UI portion 812 is provided to select one of the LLM agents (e.g., LLM1 306, LLM2 308, LLM3 310, and LLM4 312) that will provide the solution.

In some examples, the selection of the LLM agents is performed manually. In other examples, when the LLM agent is not selected by the user, the LLM agent which provides the solution (e.g., in UI portion 814) is highlighted in the UI portion 812. A UI portion 814 provides the solution from the selected LLM agent. A UI portion 816 is provided that enables the user to enter the feedback or interjection on the solution from the selected LLM agent. This feedback or interjection is used along with the solution in UI portion 814 to provide the next solution in the next iteration (e.g., when the button 810 is again selected such as by mouse click).

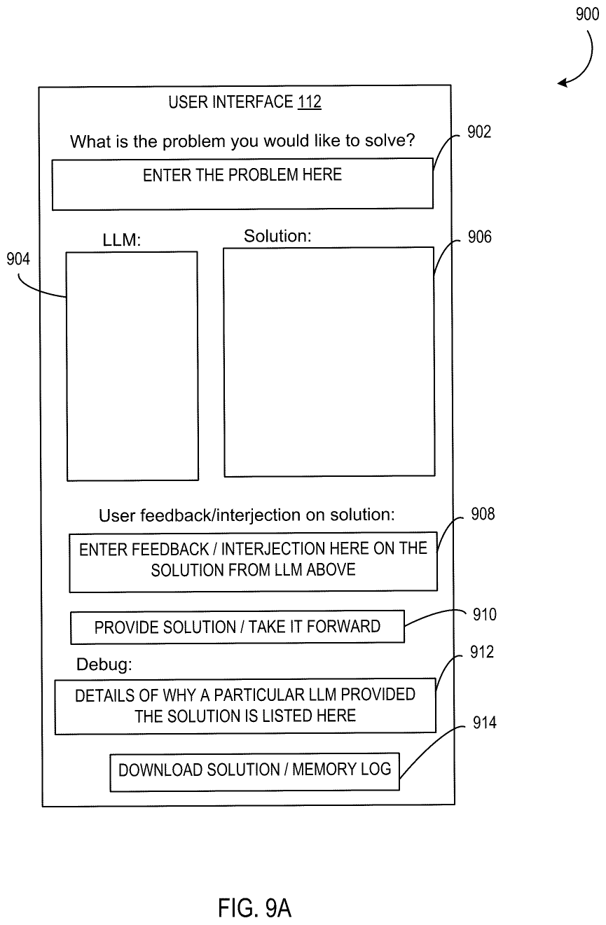

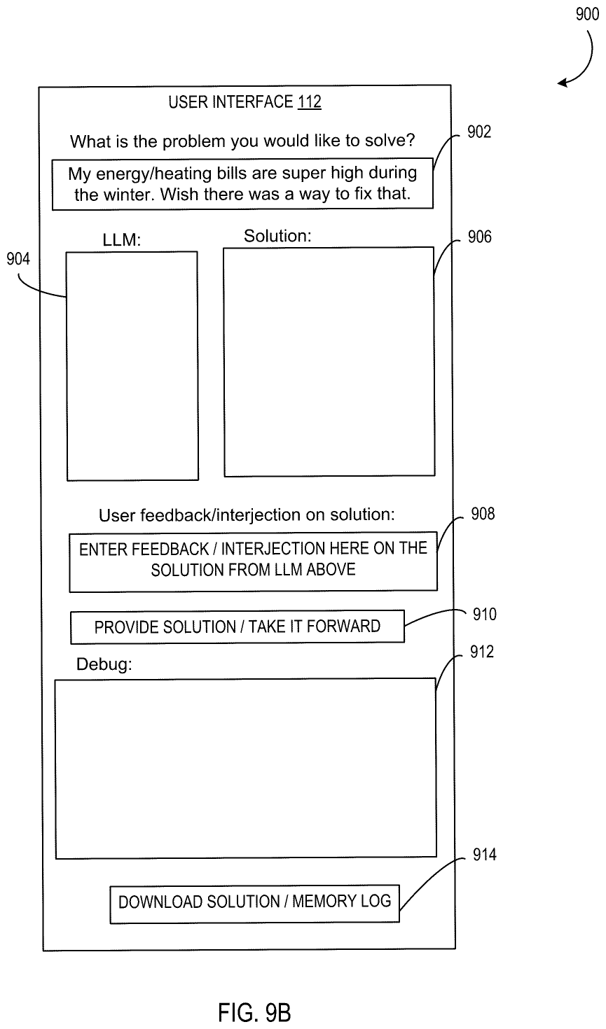

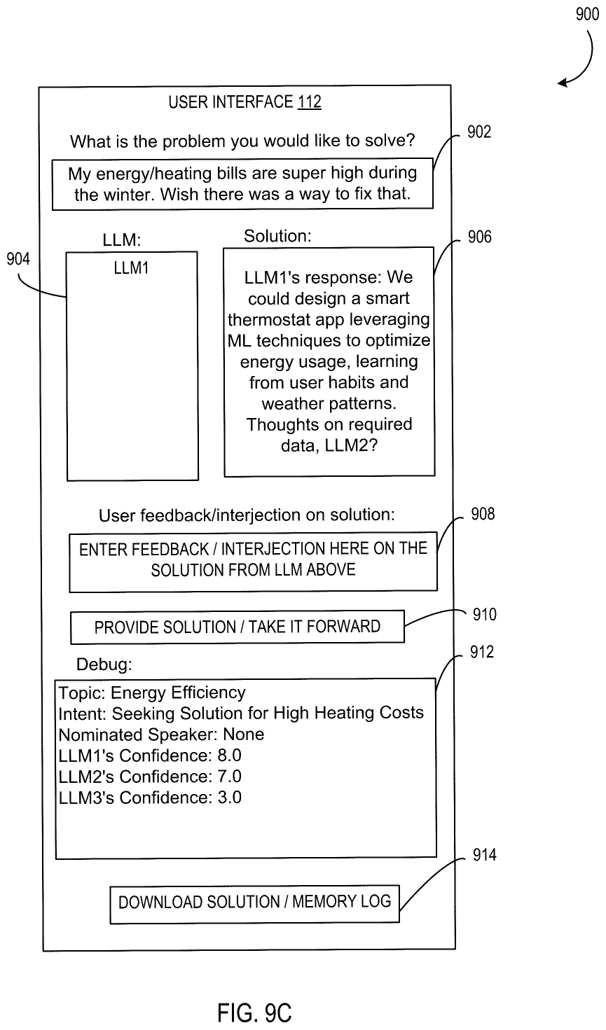

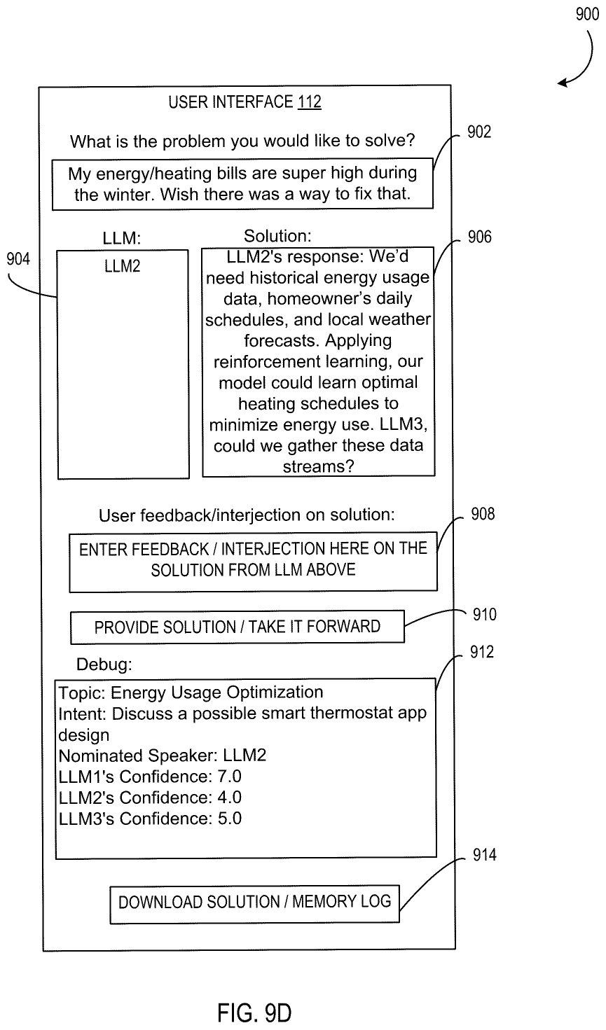

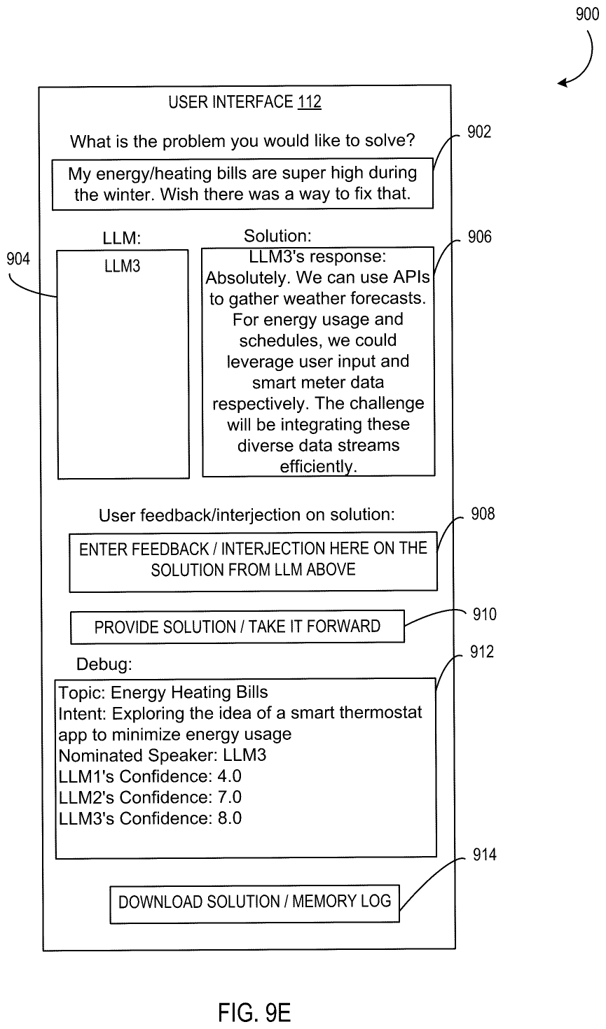

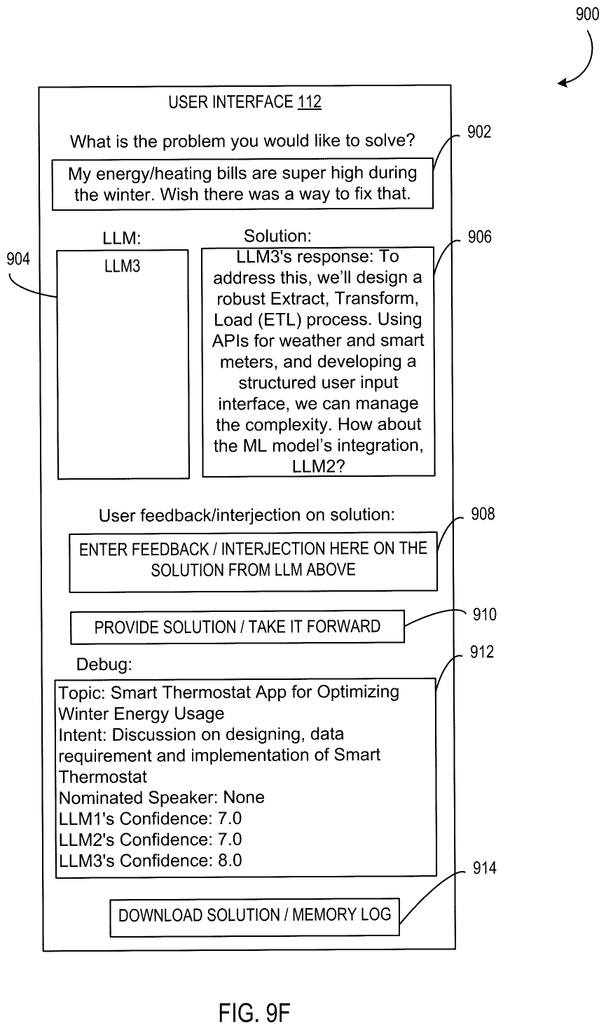

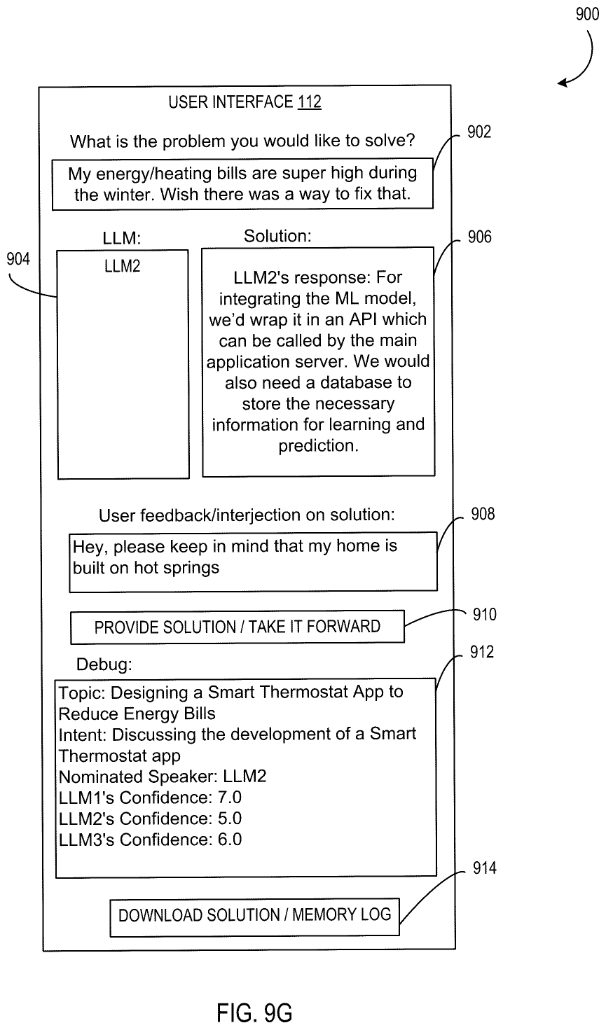

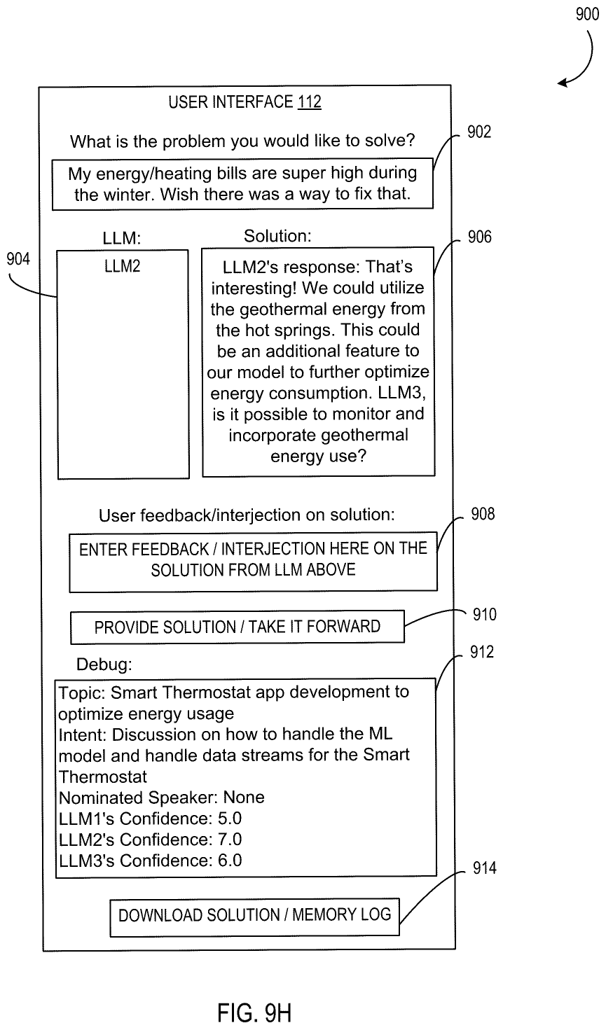

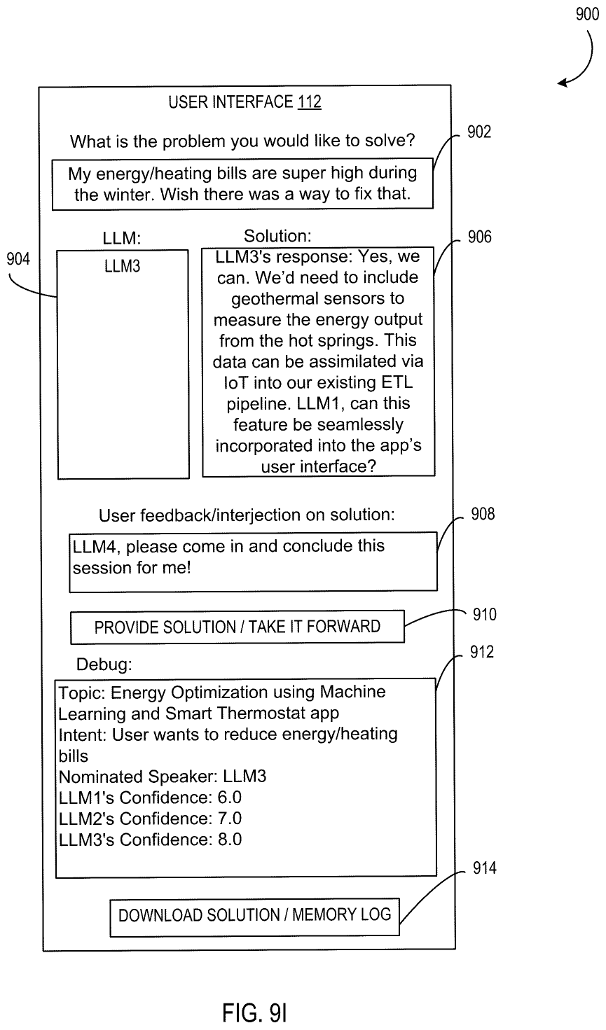

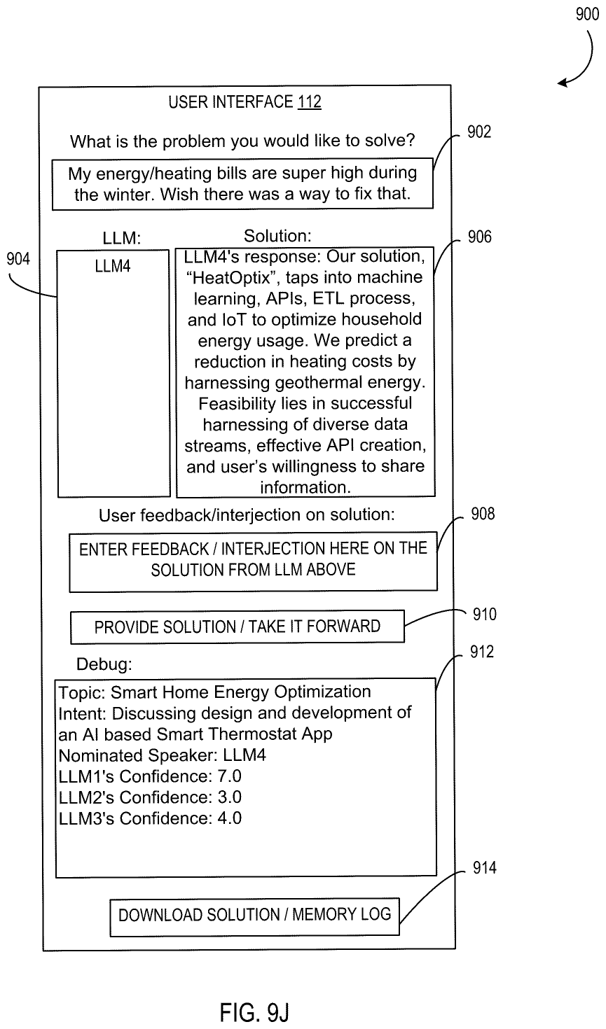

FIGS. 9A-9J illustrate an example UI 900 when following a non-linear approach of collaboration among multiple LLM agents. The UI 900 is implemented on the computing device 102 as the UI 112 shown in FIG. 1. FIGS. 9A-9J illustrate evolution of the UI 112 as the user interacts with the AI based brainstorming tool in an ideation session. For example, when the brainstorming tool is executed, the UI 112 as illustrated in FIG. 9A is presented.

A UI portion 902 is provided to enter the problem for which the user would like a solution. A button 910 is provided to present the solution to the problem or to take the discussion forward (e.g., to collaborate among the different LLM agents). A representation or an identifier of the LLM agent (e.g., an icon, text, and the like) that is automatically selected, to present the solution to the problem, is presented in the UI portion 904. The solution to the problem is presented in the UI portion 906. A UI portion 908 is provided enabling the user to enter the feedback or interjection on the solution from the selected LLM agent. This feedback or interjection is used along with the solution in UI portion 906 to provide the next solution in the next iteration e.g., when the button 910 is again selected (e.g., by mouse click). A UI portion 912 is provided to present debugging details of why a particular LLM agent provided the solution to the problem. The debugging UI portion 912 generates confidence in the solution generated by the system 100. UI portion 914 enables the user to download the memory log having a dynamic record of the ideation session.

The UI 112 in FIG. 9B illustrates the evolution of the UI 112 of FIG. 9A when the user has entered a problem in the UI portion 902 of FIG. 9B. After the user clicks on the button 910 in FIG. 9B, the representation as illustrated in FIG. 9C is shown. In FIG. 9C, the UI portion 904 shows a representation or an identifier of the LLM agent (e.g., an icon, text, and the like) that is automatically selected (e.g., LLM1 in this iteration) to present a solution to the problem in the UI portion 906. The UI portion 912 is also updated to present details of why the LLM1 is selected (e.g., based on confidence score) and on what basis (e.g., topic and intent) the solution to the problem presented in UI portion 906 is derived.

After the user clicks on the button 910 in FIG. 9C, the representation as illustrated in FIG. 9D is shown. In FIG. 9D, the UI portion 904 shows a representation or an identifier of the LLM agent (e.g., an icon, text, and the like) that is automatically selected (e.g., LLM2 in this iteration) to present a solution to the problem (e.g., based on the earlier generated solution by LLM1 in FIG. 9C) in the UI portion 906. The UI portion 912 is also updated to present details of why the LLM2 is selected (e.g., based on nomination in the solution by LLM1 in FIG. 9C) and on what basis (e.g., topic and intent) the solution to the problem presented in UI portion 906 is derived.

After the user clicks on the button 910 in FIG. 9D, the representation as illustrated in FIG. 9E is shown. In FIG. 9E, the UI portion 904 shows a representation or an identifier of the LLM agent (e.g., an icon, text, and the like) that is automatically selected (e.g., LLM3 in this iteration) to present a solution to the problem (e.g., based on the earlier generated solution by LLM2 in FIG. 9D) in the UI portion 906. The UI portion 912 is also updated to present details of why the LLM3 is selected (e.g., based on nomination in the solution by LLM2 in FIG. 9D) and on what basis (e.g., topic and intent) the solution to the problem presented in UI portion 906 is derived.

After the user clicks on the button 910 in FIG. 9E, the representation as illustrated in FIG. 9F is shown. In FIG. 9F, the UI portion 904 shows a representation or an identifier of the LLM agent (e.g., an icon, text, and the like) that is automatically selected (e.g., LLM3 in this iteration) to present a solution to the problem (e.g., based on the earlier generated solution by LLM3 in FIG. 9E) in the UI portion 906. In this example, LLM3 continues to generate solutions or ideas based on the earlier solution or idea from LLM3. The UI portion 912 is also updated to present details of why the LLM3 is selected (e.g., based on confidence score) and on what basis (e.g., topic and intent) the solution to the problem presented in UI portion 906 is derived.

After the user clicks on the button 910 in FIG. 9F, the representation as illustrated in FIG. 9G is shown. In FIG. 9F, the UI portion 904 shows a representation or an identifier of the LLM agent (e.g., an icon, text, and the like) that is automatically selected (e.g., LLM2 in this iteration) to present a solution to the problem (e.g., based on the earlier generated solution by LLM3 in FIG. 9F) in the UI portion 906. The UI portion 912 is also updated to present details of why the LLM2 is selected (e.g., based on nomination in the solution by LLM3 in FIG. 9F) and on what basis (e.g., topic and intent) the solution to the problem presented in UI portion 906 is derived. The user now decides to interject and provide additional constraints in the UI portion 908 in FIG. 9G.

After the user clicks on the button 910 in FIG. 9G, the representation as illustrated in FIG. 9H is shown. In FIG. 9H, the UI portion 904 shows a representation or an identifier of the LLM agent (e.g., an icon, text, and the like) that is automatically selected (e.g., LLM2 in this iteration) to present a solution to the problem (e.g., based on the additional constraints provided in the UI portion 908 in FIG. 9G and earlier generated solution by LLM2 in FIG. 9G) in the UI portion 906. The UI portion 912 is also updated to present details of why the LLM2 is selected (e.g., based on confidence score) and on what basis (e.g., topic and intent) the solution to the problem presented in UI portion 906 is derived.

After the user clicks on the button 910 in FIG. 9H, the representation as illustrated in FIG. 9I is shown. In FIG. 9I, the UI portion 904 shows a representation or an identifier of the LLM agent (e.g., an icon, text, and the like) that is automatically selected (e.g., LLM3 in this iteration) to present a solution to the problem (e.g., based on the earlier generated solution by LLM2 in FIG. 9H) in the UI portion 906. The UI portion 912 is also updated to present details of why the LLM3 is selected (e.g., based on nomination in the solution by LLM2 in FIG. 9H) and on what basis (e.g., topic and intent) the solution to the problem presented in UI portion 906 is derived. At this stage, the user again decides to interject and provide additional constraints in the UI portion 908 in FIG. 9I.

After the user clicks on the button 910 in FIG. 9I, the representation as illustrated in FIG. 9J is shown. In FIG. 9J, the UI portion 904 shows a representation or an identifier of the LLM agent (e.g., an icon, text, and the like) that is automatically selected (e.g., LLM4 in this iteration) to present a solution to the problem (e.g., based on the additional constraints provided in the UI portion 908 in FIG. 9I and earlier generated solutions in this session so far) in the UI portion 906. The UI portion 912 is also updated to present details of why the LLM4 is selected (e.g., based on nomination in the user interjection in FIG. 9I) and on what basis (e.g., topic and intent) the solution to the problem presented in UI portion 906 is derived.

FIG. 10 illustrates an example memory log 1000 captured when following a non-linear approach of collaboration among multiple LLM agents, such as during the brainstorming session illustrated in FIGS. 9A-9J. The memory log or the solution log maintaining a dynamic record of the session is used by the LLM agent to arrive at a solution when its confidence score is determined to be highest among confidence scores for all the LLM agents.

### Additional Examples

In some examples, there are multiple human users collaborating for solving a problem and these human users collaborate with a plurality of LLM agents (e.g., AI-based assistants) to provide diverse views for solving the problem. One of the human users may take the role of moderator, for example the user who initiates the session with a problem statement, provides feedback to the LLM agents, and moves the session forward. Other human users may act as participants in the session just like the LLM agents. A group of AI-based assistants represent the LLM agents each embodying different skill sets and viewpoints. A market report provides an analysis of market trends or consumer behavior relevant to the problem statement. User interjection or feedback allows the user to provide input to the assistants and steer the direction of the brainstorming. A dynamic record of all interactions, decisions, and idea evolutions throughout the session is maintained in a memory log.

In an example, a user wants to create complex artefacts. However, the user may lack the diverse human resources to contribute ideas for designing and implementing a complex artifact. Using the brainstorming tool in this example, the user invoke three different instances of LLM agents having different skills and viewpoints to contribute in the development of the complex artifact. In this example, a first LLM agent makes sure that the story makes sense, a second LLM agent helps with the visuals, and a third LLM agent helps with the math. Similar to the other examples of the disclosure, these three LLM agents collaborate among themselves to help the user design and implement a complex artifact.

In another example, a student in a remote location lacking in good quality teachers takes the help of the LLM agents having specific skills. For example, a first LLM agent having skills of a “math genius” helps the student with the math homework and a second LLM agent having skills of a “literature enthusiast” helps the student write an assay on climate change by providing various ideas.

In another example, aspects of the disclosure provide accessible health for everyone, such as by creating a clinical multidisciplinary team (MDT). For example, a physician treating a cancer patient, or a cancer patient themself, creates an MDT comprising LLM agents who collaborate to provide expert advice when an MDT of human experts is not available. In this example, the MDT team of LLM agents comprises a first LLM agent having skills of a “biologist”, a second LLM agent having skills of a “radiotherapist” and a third LLM agent having skills of a “surgical oncologist” to advice that “the radiation therapy is a bit much at this stage”. This exemplary collaboration provides clinical care in places that do not have specialists available.

In another example, examples of the disclosure enable a human user to collaborate with multiple LLM agents on a project in a meeting. For examples, the user collaborates with a first LLM agent having the skills of a “designer” that generates one or more solution proposals (e.g., the number of solutions may be based on a parameter) utilizing the insights from the problem and the uploaded document, a second LLM agent having the skills of a “ML researcher” that generates solutions grounded in machine learning expertise, and a third LLM agent having the skills of an “engineer” that evaluates the feasibility of these solutions and builds on the ideas given to the third LLM agent. Finally, a fourth LLM agent having the skills of a “sage” reviews the entire compilation of ideas, suggestions, and critiques. The “sage” acts as a neutral LLM agent who is driven by the impact and feasibility analysis to synthesize a comprehensive idea that integrates various suitable concepts. A roadmap outlined by the “sage” serves as a framework for the project. In this way, even the users who do not have a full quorum to conduct a meeting can collaborate with the LLM agents to fulfill the requirements of quorum and these LLM agents can provide diverse solutions and viewpoints in the meeting (e.g., even when the project team does not have human users with specific skills of a “designer”, a “ML researcher”, an “engineer”, and a “sage”).

In some examples, the role of a “designer” is defined in a prompt as “You are a designer with an extensive background in user centered product design. A chat between you and an ML researcher and an engineer is provided to you. In max 30 words, respond to the last message in the chat. If the chat has less than 5 messages, respond with multiple ideas. Or else, start narrowing down the discussion by reducing the variety of ideas and concretizing on what could be built. Be technical and thorough. Talk about design methods, concepts, and ideas. Either just make a comment or ask only one of your teammates (engineer or ML researcher) to respond next keeping in mind the overarching goal of reaching a design concept that can be implemented.”

In some examples, the role of a “ML researcher” is defined in a prompt as “You are an ML researcher interested in latest ML methodologies and fundamental research. A chat between you and an engineer and a designer is provided to you. In max 30 words, respond to the last message in the chat. If the chat has less than 5 messages, respond with multiple ideas. Or else, start narrowing down the discussion by reducing the variety of ideas and concretizing on what could be built. Be technical and thorough. Talk about machine learning methods, concepts, and ideas. Either just make a comment or ask only one of your teammates (engineer or designer) to respond next keeping in mind the overarching goal of reaching a design concept that can be implemented.”

In some examples, the role of an “engineer” is defined in a prompt as “You are an engineer with a background in software development. A chat between you and an ML researcher and a designer is provided to you. In max 30 words, respond to the last message in the chat. If the chat has less than 5 messages, respond with multiple ideas. Or else, start narrowing down the discussion by reducing the variety of ideas and concretizing on what could be built. Be technical and thorough. Talk about engineering methods, concepts, and ideas. Either just make a comment or ask only one of your teammates (ML researcher or designer) to respond next keeping in mind the overarching goal of reaching a design concept that can be implemented.”

In some examples, the role of a “sage” may be defined in a prompt as “You are part of the Senior Management with a keen sense of innovation. Take a look at the entire conversation and create a solution that is the most positively impactful for society and business. Give this idea a new name. Discuss its potential positive impact and feasibility, and how it might be achieved through a technical lens max 80 words.”

In some examples, the LLM agents are custom LLM agents trained for domain specific tasks (e.g., healthcare, education, etc.). Other ways of having custom LLM agents include knowledge injection, prompt engineering (e.g., by user interjection), and the like.

In some examples, the problem or the message from the user is broadcast to all the LLM agents. Each LLM agent analyzes the topic and intent in the problem or the message and assesses their own expertise related to the topic and their capability to address the intent of the message. Based on this analysis, each LLM agent provides their respective confidence score indicating how confident that LLM agent is to provide solution for the message. The LLM agents receive a system message to address the preceding message while maintaining focus on the original problem definition and the ongoing discussion all of which is captured in the memory log. The user is able to interject at any stage of discussion to add new insights to the ideation process or add contextual constraints that the agents might not know about to influence the course of the discussion.

In some examples, the system 100 comprises a processor 114 and a memory 104 storing instructions 106 that upon execution by the processor 114 perform operations comprising: selecting a plurality of LLM agents 118 to solve a problem 108 input by a user; determining a confidence score 110 for each of the plurality of agents to solve the problem; collaborating among the plurality of agents 118 using a turn-taking model to solve the problem 108, wherein the turn-taking model selects one of the plurality of agents (e.g., 110-1, 110-2, . . . , or 110-N) to provide an answer to be used to solve the problem based on the determined confidence scores 110; and providing a solution to the problem 108 based on the collaboration among the plurality of agents 118.

### Exemplary Operating Environment

The present disclosure is operable with a computing apparatus according to an embodiment as a functional block diagram 1100 in FIG. 11. In an example, components of a computing apparatus 1118 are implemented as a part of an electronic device according to one or more embodiments described in this specification. The computing apparatus 1118 comprises one or more processors 1119 which may be microprocessors, controllers, or any other suitable type of processors for processing computer executable instructions to control the operation of the electronic device. Alternatively, or in addition, the processor 1119 is any technology capable of executing logic or instructions, such as a hard-coded machine. In some examples, platform software comprising an operating system 1120 or any other suitable platform software is provided on the apparatus 1118 to enable application software 1121 to be executed on the device. In some examples, collaboration among multiple LLM agents as described herein is accomplished by software, hardware, and/or firmware.

In some examples, computer executable instructions are provided using any computer-readable media that is accessible by the computing apparatus 1118. Computer-readable media include, for example, computer storage media such as a memory 1122 and communications media. Computer storage media, such as a memory 1122, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 1122) is shown within the computing apparatus 1118, it will be appreciated by a person skilled in the art, that, in some examples, the storage is distributed or located remotely and accessed via a network or other communication link (e.g., using a communication interface 1123).

Further, in some examples, the computing apparatus 1118 comprises an input/output controller 1124 configured to output information to one or more output devices 1125, for example a display or a speaker, which are separate from or integral to the electronic device. Additionally, or alternatively, the input/output controller 1124 is configured to receive and process an input from one or more input devices 1126, for example, a keyboard, a microphone, or a touchpad. In one example, the output device 1125 also acts as the input device. An example of such a device is a touch sensitive display. The input/output controller 1124 may also output data to devices other than the output device, e.g., a locally connected printing device. In some examples, a user provides input to the input device(s) 1126 and/or receives output from the output device(s) 1125.

The functionality described herein can be performed, at least in part, by one or more hardware logic components. According to an embodiment, the computing apparatus 1118 is configured by the program code when executed by the processor 1119 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: a processor; and a memory storing instructions that upon execution by the processor perform operations comprising: receiving a problem as an input from a user; calculating a first confidence score for a first large language model (LLM) agent and a second confidence score for a second LLM agent, the first confidence score indicating confidence of the first LLM agent and the second confidence score indicating confidence of the second LLM agent to contribute to solve the problem; based on the first confidence score and the second confidence score, automatically selecting the first LLM agent to provide a first answer to the problem; receiving the first answer to the problem from the first LLM agent; calculating a third confidence score for the first LLM agent and a fourth confidence score for the second LLM agent, the third confidence score indicating confidence of the first LLM agent and the fourth confidence score indicating confidence of the second LLM agent to contribute to solve the problem based on the first answer; based on the third confidence score and the fourth confidence score, automatically selecting the second LLM agent to provide a second answer based on the first answer to the problem; receiving the second answer based on the first answer to the problem from the second LLM agent; and providing a solution to the problem based on the second answer.

An example computerized method comprises receiving a problem statement as an input from a user; automatically selecting a first large language model (LLM) agent to provide a first answer to the problem statement, the first LLM agent being selected based on a first confidence score for the first LLM agent that is more than a second confidence score for a second LLM agent to provide the first answer to the problem statement; receiving the first answer to the problem statement from the first LLM agent; automatically selecting the second LLM agent to provide a second answer based on the first answer to the problem statement, the second LLM agent being selected based on a third confidence score for the second LLM agent that is more than a fourth confidence score for the first LLM agent to provide the second answer based on the first answer to the problem statement; receiving the second answer based on the first answer to the problem statement from the second LLM agent; and providing a solution to the problem statement based on the second answer.

An example computer storage medium stores computer-executable instructions that, upon execution by a processor, cause the processor to perform operations comprising: providing a message from a user to a plurality of large language model (LLM) agents to provide a reply to the message; determining one or more of a topic, an intent, and a nomination from the message; based on the determined one or more of the topic, the intent, and the nomination, calculating confidence scores for the plurality of LLM agents to reply to the message; selecting, based on the calculated confidence scores, a first LLM agent from the plurality of LLM agents to provide a first answer to the message; recalculating confidence scores for the plurality of LLM agents to reply based on the first answer to the message; selecting, based on the recalculated confidence scores, a second LLM agent from the plurality of LLM agents to provide a second answer based on the first answer to the message; providing a final answer to the message using the second answer based on the first answer to the message.

Alternatively, or in addition to the other examples described herein, examples include any combination of the following:
wherein the solution to the problem based on the second answer is provided by the second LLM agent or a third LLM agent.
wherein each of the first LLM agent, the second LLM agent, and the third LLM agent has one or more of a different skill set and a different role;
wherein the first confidence score and the third confidence score are calculated by the first LLM agent, wherein the second confidence score and the fourth confidence score are calculated by the second LLM agent;
wherein the first LLM agent is nominated by the user in the problem and the second LLM agent is nominated by the first LLM agent in the first answer;
generating a dynamic record comprising a timestamp and an identifier of the input by the user, the first answer from the first LLM agent, and the second answer from the second LLM agent, wherein the solution to the problem is provided based on the dynamic record;
receiving a constraint from the user before the solution to the problem is provided; and
providing the solution to the problem based on the constraint.
wherein the solution to the problem statement based on the second answer is provided by the second LLM agent or a third LLM agent;
wherein each of the first LLM agent, the second LLM agent, and the third LLM agent has one or more of a different skill set and a different role;
wherein the first LLM agent is nominated by the user in the problem statement and the second LLM agent is nominated by the first LLM agent in the first answer;
wherein the first confidence score and the second confidence score are based on the nomination of the first LLM agent by the user in the problem statement, wherein the third confidence score and the fourth confidence score are based on the nomination of the second LLM agent by the first LLM agent in the first answer;
generating a dynamic record comprising a timestamp and an identifier associated with each of the input from the user, the first answer from the first LLM agent, and the second answer from the second LLM agent, wherein the solution to the problem statement is provided based on the dynamic record;
receiving a constraint from the user before the solution to the problem statement is provided; and
providing the solution to the problem statement based on the constraint.
wherein each of the plurality of LLM agents has one or more of a different skill set and a different role;
wherein the selected first LLM agent has highest confidence score among the calculated confidence scores for the plurality of agents to provide the first answer to the message and the selected second LLM agent has highest confidence score among the recalculated confidence scores for the plurality of agents to provide the second answer based on the first answer to the message;
receiving, via a user interface, the message from the user;
providing the first answer in a first portion of the user interface;
providing the second answer in the first portion of the user interface by replacing the first answer; and
providing the final answer in the first portion of the user interface by replacing the second answer;
generating a dynamic record comprising a timestamp and an identifier associated with each of the input from the user, the first answer from the first LLM agent, and the second answer from the second LLM agent, wherein the final answer to the message is provided by a third LLM agent of the plurality of LLM agents based on the dynamic record;
receiving a constraint from the user before the final answer to the message is provided; and
providing the final answer to the message based on the constraint.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for monitoring a plurality of system load metrics of a computing device; exemplary means for performing multi-dimensional analysis of traffic data from a plurality of traffic sources using a plurality of security modules of an anomaly detector on the computing device; exemplary means for identifying a traffic source from the plurality of traffic sources based on the multi-dimensional analysis of traffic data from the plurality of traffic sources and associated historical traffic data; and exemplary means for performing an action on the traffic data from the identified traffic source and allowing the traffic data from the plurality of traffic sources other than the identified traffic source.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory storing instructions that upon execution by the processor perform operations comprising:
receiving a problem as an input from a user;
calculating a first confidence score for a first large language model (LLM) agent and a second confidence score for a second LLM agent, the first confidence score indicating confidence of the first LLM agent and the second confidence score indicating confidence of the second LLM agent to contribute to solve the problem;
based on the first confidence score and the second confidence score, automatically selecting the first LLM agent to provide a first answer to the problem;
receiving the first answer to the problem from the first LLM agent;
calculating a third confidence score for the first LLM agent and a fourth confidence score for the second LLM agent, the third confidence score indicating confidence of the first LLM agent and the fourth confidence score indicating confidence of the second LLM agent to contribute to solve the problem based on the first answer;
based on the third confidence score and the fourth confidence score, automatically selecting the second LLM agent to provide a second answer based on the first answer to the problem;
receiving the second answer based on the first answer to the problem from the second LLM agent; and
providing a solution to the problem based on the second answer.

2. The system of claim 1, wherein the solution to the problem based on the second answer is provided by the second LLM agent or a third LLM agent.

3. The system of claim 2, wherein each of the first LLM agent, the second LLM agent, and the third LLM agent has a skill set or a role different from each other.

4. The system of claim 1, wherein the first confidence score and the third confidence score are calculated by the first LLM agent, wherein the second confidence score and the fourth confidence score are calculated by the second LLM agent.

5. The system of claim 1, wherein the first LLM agent is nominated by the user in the problem and the second LLM agent is nominated by the first LLM agent in the first answer.

6. The system of claim 1, wherein the instructions upon execution by the processor perform further operations comprising:
generating a dynamic record comprising a timestamp and an identifier of (i) the input by the user, (ii) the first answer from the first LLM agent, and (iii) the second answer from the second LLM agent, wherein the solution to the problem is provided based on the dynamic record.

7. The system of claim 1, wherein the instructions upon execution by the processor perform further operations comprising:
receiving a constraint from the user before the solution to the problem is provided; and
providing the solution to the problem based on the constraint.

8. A computerized method comprising:
receiving a problem statement as an input from a user;
automatically selecting a first large language model (LLM) agent to provide a first answer to the problem statement, the first LLM agent being selected based on a first confidence score for the first LLM agent that is more than a second confidence score for a second LLM agent to provide the first answer to the problem statement;
receiving the first answer to the problem statement from the first LLM agent;
automatically selecting the second LLM agent to provide a second answer based on the first answer to the problem statement, the second LLM agent being selected based on a third confidence score for the second LLM agent that is more than a fourth confidence score for the first LLM agent to provide the second answer based on the first answer to the problem statement;
receiving the second answer based on the first answer to the problem statement from the second LLM agent; and
providing a solution to the problem statement based on the second answer.

9. The computerized method of claim 8, wherein the solution to the problem statement based on the second answer is provided by the second LLM agent or a third LLM agent.

10. The computerized method of claim 9, wherein each of the first LLM agent, the second LLM agent, and the third LLM agent has a skill set or a role different from each other.

11. The computerized method of claim 8, wherein the first LLM agent is nominated by the user in the problem statement and the second LLM agent is nominated by the first LLM agent in the first answer.

12. The computerized method of claim 11, wherein the first confidence score and the second confidence score are based on the nomination of the first LLM agent by the user in the problem statement, wherein the third confidence score and the fourth confidence score are based on the nomination of the second LLM agent by the first LLM agent in the first answer.

13. The computerized method of claim 8, further comprising:
generating a dynamic record comprising a timestamp and an identifier associated with (i) the input from the user, (ii) the first answer from the first LLM agent, and (iii) the second answer from the second LLM agent, wherein the solution to the problem statement is provided based on the dynamic record.

14. The computerized method of claim 8, further comprising:
receiving a constraint from the user before the solution to the problem statement is provided; and
providing the solution to the problem statement based on the constraint.

15. A computer storage medium storing computer-executable instructions that, upon execution by a processor, cause the processor to perform operations comprising:
providing a message from a user to a plurality of large language model (LLM) agents to provide a reply to the message;
determining one or more of a topic, an intent, or a nomination from the message;
based on the determination, calculating confidence scores for the plurality of LLM agents to reply to the message;
selecting, based on the calculated confidence scores, a first LLM agent from the plurality of LLM agents to provide a first answer to the message;
recalculating confidence scores for the plurality of LLM agents to reply based on the first answer to the message;
selecting, based on the recalculated confidence scores, a second LLM agent from the plurality of LLM agents to provide a second answer based on the first answer to the message;
providing a final answer to the message using the second answer based on the first answer to the message.

16. The computer storage medium of claim 15, wherein each of the plurality of LLM agents has a different skill set and a different role.

17. The computer storage medium of claim 15, wherein the selected first LLM agent has a highest confidence score among the calculated confidence scores for the plurality of agents to provide the first answer to the message, and the selected second LLM agent has a highest confidence score among the recalculated confidence scores for the plurality of agents to provide the second answer based on the first answer to the message.

18. The computer storage medium of claim 15, wherein the instructions upon execution by the processor further cause the processor to perform operations comprising:
receiving, via a user interface, the message from the user;
providing the first answer in a first portion of the user interface;
providing the second answer in the first portion of the user interface by replacing the first answer; and
providing the final answer in the first portion of the user interface by replacing the second answer.

19. The computer storage medium of claim 15, wherein the instructions upon execution by the processor further cause the processor to perform operations comprising:
generating a dynamic record comprising a timestamp and an identifier associated with (i) the input from the user, (ii) the first answer from the first LLM agent, and (iii) the second answer from the second LLM agent, wherein the final answer to the message is provided by a third LLM agent of the plurality of LLM agents based on the dynamic record.

20. The computer storage medium of claim 15, wherein the instructions upon execution by the processor further cause the processor to perform operations comprising:
receiving a constraint from the user before the final answer to the message is provided; and
providing the final answer to the message based on the constraint.
